(19) United States
(12) Patent Application Publication
(10) Pub. No.: US 2015/0312339 A1
(43) Pub. Date: Oct. 29, 2015

(54) METHOD AND SYSTEM FOR BANDWIDTH-DEPENDENT FILE TRANSFER

(71) Applicant: Alibaba Group Holding Limited, Grand Cayman (KY)

(72) Inventor: Cheng Chen, Hangzhou (CN)

(21) Appl. No.: 14/696,150

(22) Filed: Apr. 24, 2015

(30) Foreign Application Priority Data
Apr. 25, 2014 (CN) 201410171672.9

(51) Int. Cl. H04L 29/08; H04L 12/26

(52) U.S. Cl. CPC H04L 67/1095; H04L 43/0882

(57) ABSTRACT

A method and system for bandwidth-dependent file transferring. A server sends a webpage code to a client to instruct the client to measure or update a current bandwidth value. The server receives from the client a request for reading a file, which is located at the server and can be read at various quality levels. A quality level of the requested file appropriate to the current bandwidth value is selected to allow the server to send to the client the requested file at the selected quality level. The bandwidth value can be calculated by measuring the speed of reading a previously requested file, and updated by measuring the speed of reading the current requested file.

### RELATED PATENT APPLICATIONS

This application claims foreign priority to Chinese Patent Application No. 201410171672.9 filed on Apr. 25, 2014, entitled “METHOD AND SYSTEM FOR BANDWIDTH-DEPENDENT FILE TRANSFER”, which is hereby incorporated by reference in its entirety.

### TECHNICAL FIELD

This application relates to the field of computer communications technology, particularly to a method and a system for bandwidth-dependent file transfer.

### BACKGROUND

Thanks to modern data communication technologies and the rapid development of the network, users can use a browser to browse images, texts videos and many other file formats stored on a server.

Internet users have a general need to browse files on the server. In a process of file browsing, the user uses the client browser to send a browsing request to the server, and upon receiving the user request, the server returns data to the client browser, which displays the received data to the user. Usually the files browsed by the user contain image files and other files that may have a large amount of data.

Due to variations of network conditions in different locations or different time periods, many users suffer low network speed. Under such network conditions, the webpages that contain data-intensive images and videos can be slow to open, affecting user browsing experience.

Usually, files that contain a large amount of data can be compressed to reduce the amount of data and improve webpage access speed. For example, the data size of a picture may be reduced by compressing the image file. The image quality is usually measured by the image compression ratio. If a picture's original file size is 2.5 MB (megabytes), a 100% quality copy of the picture corresponds to a picture size of 2.5 MB. An 80% quality copy of the picture may correspond to a file size of 1.15 MB, a 50% quality copy of the picture may correspond to a file size of 692 KB (kilobytes), while a 30% quality copy may correspond to a file size of 341 KB. For human eyes, the perceived quality difference between a picture of 100% quality and a copy of the same picture of 30% quality is not large, and the difference between that of 100% quality and 80% quality is almost unperceivable. However, the differences of the file sizes of the 100%, 80% and 30% picture quality are quite large. Given the same network speed, the speed of transferring is faster with a smaller file size. Therefore, in order to accelerate the speed of opening webpages, the amount of data that needs to be transferred is reduced by compressing the picture and video files in a webpage. In order to do this, the bandwidth (Internet speed) may be first measured, and a decision is made whether to reduce the file sizes of the data-intensive files, and if yes, by how much.

One of the existing methods of measuring the bandwidth is to use a fixed-resource file that has a fixed size. Specifically, a fixed-resource file having a fixed size is placed on the Web server. The fixed-resource file may be an image, a video or any other suitable format, but is usually not part of the webpage content. The user browser determines the time it takes to receive the fixed-resource file, and uses the determined time to calculate a value of the bandwidth, which is stored at the client. The client requests files of a certain quality according to the determined network bandwidth.

The existing method has a problem in practice. At the time when the request for webpage files is made, the value of the bandwidth available may be the one that was measured initially, and as a result any changes to the network condition since then until the present time is not taken into account. If the user has switched to a different network, or moved to a different geographic location, the network speed may have changed. The prior art does not provide a way to update the network speed, and as a result, the quality of the files sent to the client may not be optimal for the client's current network speed. For example, if the current network speed has been reduced from the initial speed, the browser would request files of overly high quality to cause longer receiving time under the current network conditions. Likewise, if the current network speed has been increased from the initial speed, the browser would request files of an unnecessarily low quality.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

One aspect of this disclosure is a method for bandwidth-dependent file transferring. According to the method, a server sends a webpage code to a client to instruct the client to measure or update a current bandwidth measurement. The server receives from the client a request for reading a file, which is located at the server and can be read at various quality levels. A quality level of the requested file appropriate to the current bandwidth measurement is selected to allow the server to send the requested file to the client at the appropriate quality level.

The bandwidth measurement can be made by measuring the speed of reading a previously requested file, and updated by measuring the speed of reading the current requested file.

The webpage code sent to the client concerns the current bandwidth. For example, the webpage code may contain corresponding relationships between the various quality levels and various values of the current bandwidth measurement.

In an embodiment, the method provides a plurality of versions of the requested file, each version representing one of the various quality levels. To send the requested file at the selected quality level to the client, the server sends one of the plurality of versions representing the selected one of the various quality levels.

The plurality of versions of the requested file may be obtained by pre-processing the requested file and storing at the server. Alternatively, the plurality of versions of the requested file may be obtained by processing the requested file upon receiving from the client a request for reading the file.

To select one of the various quality levels of the requested file appropriate to the current bandwidth, the method may determine, at the client, one of the various quality levels according to the current bandwidth, and specify the determined quality level in the request for reading the file. Alternatively, the method may pre-configure a bandwidth-quality table which relates various ranges of the bandwidth to the various quality levels, and select, according to the bandwidth-quality table, one of the various quality levels of the requested file corresponding to the current bandwidth.

In an embodiment, the bandwidth-quality table is available at the server, and the server selects one of the various quality levels of the requested file appropriate to the current bandwidth. Alternatively, the bandwidth-quality table may be available at the client, and the client selects one of the various quality levels of the requested file appropriate to the current bandwidth.

The request sent by the client to the server for reading the file may specify one of the various quality levels appropriate to the current bandwidth, or specify a value of the current bandwidth.

The current bandwidth value may have been calculated from a speed of reading a previous file by the client. The previous file may be an image file having a file size calculated by multiplying a pixel number in length, a pixel number in height and an imaging coefficient, and the speed of reading the previous file may be calculated by dividing the file size by a time taken to receive the image file. The previous file read by the client may be a part of a webpage requested by the client.

The current bandwidth may be calculated from averaging speeds of reading a plurality of previous file by the client.

According to another aspect of this disclosed method for bandwidth-dependent file transferring, the server receives from the client a request for reading a file, which is located at the server and can be read at various quality levels. A quality level of the requested file appropriate to the current bandwidth is selected to allow the server to send to the client the requested file at the selected quality level. The server then instructs the client to update the current bandwidth according to, at least partially, a speed that the client has read the requested file. The updated current bandwidth is used for reading a next file or browsing a next webpage.

Another aspect of this disclosure is a computerized system for bandwidth-dependent file transferring. The system has a computing device having a processor, computer-readable memory and storage medium, and I/O devices, and the computing device is programmed to perform acts including sending to a client a webpage code concerning a current bandwidth; receiving from the client a request for reading a file at a server, wherein the file can be sent at various quality levels; selecting one of the various quality levels of the requested file appropriate to the current bandwidth; and sending from the server to the client the requested file at the selected quality level.

Other features of the present disclosure and advantages will be set forth in the following description, and in part will become apparent from the description, or understood by practice of the application. Purposes of this application and other advantages can be obtained by the written description, claims, and drawings of the structure particularly pointed out realized and attained.

### BRIEF DESCRIPTION OF THE FIGURES

The detailed description is described with reference to the accompanying figures.

FIG. 1 is a flow chart of an example of the disclosed method of bandwidth-dependent file transfer.

FIG. 2 is a flowchart of a client-centric process of the disclosed method for bandwidth-dependent file transfer.

FIG. 3 is a flowchart of a server-centric process of the disclosed method for bandwidth-dependent file transfer.

FIG. 4 is a block diagram of a system implementing a client-centric process of the disclosed method for bandwidth-dependent file transfer.

FIG. 5 is a block diagram of a record calculation unit used in the system of FIG. 4 for implementing a client-centric process of the disclosed method for bandwidth-dependent file transfer.

FIG. 6 is a block diagram of a system implementing a server-centric process of the disclosed method for bandwidth-dependent file transfer.

### DETAILED DESCRIPTION

The present disclosure is described in further detail in conjunction with accompanying figures and example embodiments. In the description, the term “technique(s),” for instance, may refer to a method, an apparatus device, a system, and/or computer-readable instructions as permitted by the context above and throughout the present disclosure.

In this description, the order in which a process is described is not intended to be construed as a limitation, and any number of the described process blocks may be combined in any order to implement the method, or an alternate method. An embodiment is described in sequential steps only for the convenience of illustration. Unless it would cause a conflict, the examples and embodiments described in the present disclosure, and the characteristics and features thereof, may be combined freely. Further, not every step described in the embodiments is required in order to practice the techniques of this disclosure.

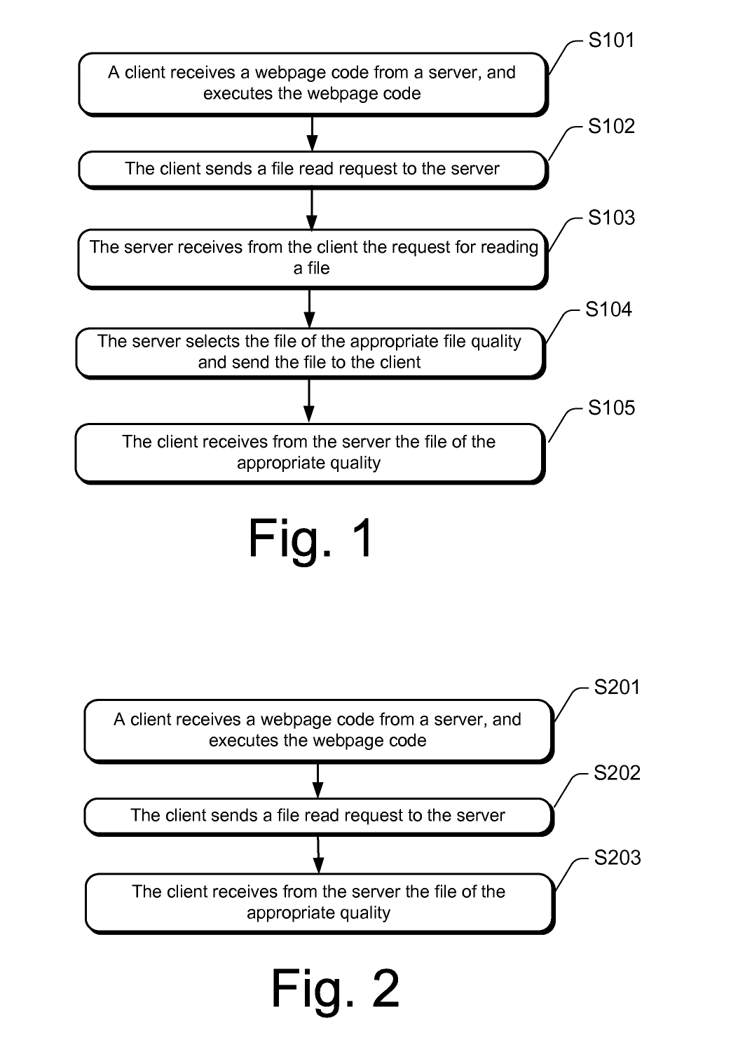

FIG. 1 is a flow chart of an example of the disclosed method of bandwidth-dependent file transfer.

At block S101, a client receives a webpage code from a server, and executes the webpage code.

The webpage code may contain codes that query for or request a current bandwidth value. The page can also contain codes to select the file quality according to the bandwidth value.

At block S102, the client sends a file read request to the server.

The request may include the current bandwidth value, or file quality selected according to the current bandwidth value.

Files of different qualities of the original file can be obtained by compressing the original file, with different compression rate resulting in a version of the corresponding quality level. The file quality may be used to represent a ratio between the original file size and the compressed file size. The size of a file may be a storage size occupied by the file when saved. Examples of compressible files include image, video, audio and other file formats.

For example, one can use an image quality to represent the image compression ratio. With an original image file having a size of 2.5 MB (megabytes), a 100% picture quality corresponds to a file size of 2.5 MB. Example relationships between the quality and image size after compression are: a 80% picture quality corresponds to a picture sizes of 1.15 MB, a 50% picture quality corresponds to a picture size of 692 KB (in kilobytes), a 30% picture quality corresponds to a picture size of 341 KB, and a 10% picture quality corresponds to a picture size of 223 KB, etc.

The current bandwidth value may include the client bandwidth values obtained in a previous file transfer. The file whose receiving speed is used for measuring the bandwidth value may be an inherent part of a webpage visited by the client. Or, the current bandwidth value may be a bandwidth value calculated by downloading a fixed-resource file that is used for such bandwidth value measurement purpose. The current bandwidth value may also be null.

The current bandwidth value has a corresponding relationship with the file quality. The corresponding relationship may be defined according to a rule. For example, a higher bandwidth value corresponds to a higher quality, and vice versa. The corresponding relationship between the current bandwidth value and the file quality can be preset, or provided in time based on user feedback.

The client may choose an appropriate file quality according to the current bandwidth value with reference to the corresponding relationship between the current bandwidth value and the file quality. If the current bandwidth value is null, that is, no current bandwidth value is available, the client may select the highest quality by default.

An example of the relationship between the current bandwidth value and file quality is shown in TABLE 1.

TABLE 1

| Bandwidth Value | File Quality |
|---|---|
| Bandwidth ≧ 4 Mbps | 100% |
| 2 Mbps ≦ bandwidth < 4 Mbps | 80% |
| 1 Mbps ≦ bandwidth < 2 Mbps | 50% |
| 512 Kbps ≦ bandwidth < 1 Mbps | 30% |
| Bandwidth < 512 Kbps | 10% |

According to the relationship shown in TABLE one, when a client's current bandwidth value is 3 Mbps, one can select a file corresponding to the 80% file quality.

At block S103, the server receives from the client the request for reading a file. The request may include a value of the current bandwidth, or the file quality corresponding to the current bandwidth value.

At block S104, the server selects the file of the appropriate file quality and sends the file to the client.

The method provides multiple versions of the requested file, each version representing one of the various quality levels. To send the requested file at the selected quality level to the client, the server sends one of versions that represents the selected quality level.

When the request to read a file contains the current bandwidth value, the server may select the corresponding file quality based on the corresponding relationship between the current bandwidth value and the file quality as described in Block S102. The server then selects an appropriate file corresponding to the selected file quality, and sends the selected file to the client. When the requests to read the file specifies the file quality corresponding to the current bandwidth value, the server selects an appropriate file corresponding to the received file quality and sends the selected file to the client.

The association between the file and its corresponding file quality may be achieved using URL (Uniform Resource Locator) addresses. For example, a unique URL address may be set for each file quality to locate a version of the file corresponding to the respective file quality.

For a picture file named “A.jpg”, for instance, the URL of the compressed image file of 50% quality may be set to be “http://domain/a.jpg_q50.jpg”. The URL of the compressed image file of 80% quality of the same original picture file may be set to be “http://domain/a.jpg_q80.jpg”.

The requested file may be preprocessed to obtain the different compression versions of the requested file, which are stored at the server at corresponding URL addresses. The server selects the URL corresponding to the current file quality, visits the URL to retrieve the corresponding version of file and return it to the client.

Alternatively, the requested file may be processed to obtain the different compression versions of the requested file upon receiving from the client the request for reading the file. For example, the server may set a URL for each file quality, but does not preprocess the file to obtain and store compressed files at these URL addresses until requested. When requested, the server analyzes the URL corresponding to the current file quality to determine an appropriate file quality, processes the original file accordingly to obtain a compressed file of the appropriate file quality, and returns the compressed file to the client.

At block S105, the client receives from the server the file of the appropriate quality.

Upon receiving files returned from the server, the client records size of each file received, and the time spent on receiving each file.

Based on the file size and the time to receive the file, the client may calculate a new value of the current bandwidth value and update it. Specifically, according to the size of each file and the time required to receive the file, the client may calculate a bandwidth value for each file separately, and calculate an average current bandwidth value for all files received using the bandwidth values calculated separately for these files. The current bandwidth value may be set to be the average bandwidth value, and stored at the client.

The bandwidth value for each file may be calculated using the following equation:

$${BW}_{n} = \frac{{S}_{n}}{{t}_{n}} , \qquad ( 1 )$$

Where n stands for the n-th file; BWₙ stands for the bandwidth value for receiving the n-th file, measured in a proper unit (e.g., Kbps); Sₙ stands for the file size of the n-th file, in thousand byte (KB) for example; and tₙ stands for the time needed to receive the n-th file, in seconds (s).

For example, when the file is a picture file, its file size can be expressed as a multiplication of the number of pixels in length, the number of pixels in height and an image coefficient, which represents the storage space occupied by each pixel. In this case, the above equation (1) can be turned into:

$${BW}_{n} = \frac{{L}_{n} \times {H}_{n} \times m}{{t}_{n}} , \qquad ( 2 )$$

Where Lₙ is the number of pixels in length; Hₙ is the number of pixels in height, m is the image coefficient, in kilobytes (KB). The value of the image coefficient m can be set based on testing the pixel storage sizes. An example coefficient value is 0.00016 KB (per pixel).

The client's current average bandwidth value is calculated by totaling the bandwidth values to receive each file, and dividing the total by the number of files received.

For example, suppose the current client received N files in a session. The bandwidth value of the n-th file is BWₙ. The range of n is 1≦n≦N. The client's current average bandwidth value BW_{average} is calculated by:

$${BW}_{average} = \frac{{\sum }_{n = 1}^{N} {BW}_{n}}{N} \qquad ( 3 )$$

The calculated average bandwidth value BW_{average} is set to be the current bandwidth value for the client, and stored. The current bandwidth value may be stored on the client.

The disclosed method is further described below from a client-centric point of view.

FIG. 2 is a flowchart of a client-centric process of the disclosed method for bandwidth-dependent file transfer.

At block S201, a client receives a webpage code from a server, and executes the webpage code. The webpage code may contain codes that query for or request a current bandwidth value. The page can also contain code to select the file quality according to the bandwidth value.

At block S202, the client sends a file read request to the server.

The request may include the current bandwidth value, or file quality selected according to the current bandwidth value.

Files of different qualities of the original file can be obtained by compressing the original file, with different compression rate resulting in a version of the corresponding quality level. The file quality may be used to represent a ratio between the original file size and the compressed file size. The size of a file may include a storage size occupied by the file when saved. The examples of compressible files may include image, video, audio and other file formats.

The current bandwidth value may include the client bandwidth values obtained in a previous file transfer. The file whose transfer is used for measuring the bandwidth value may be an inherent part of a webpage visited by the client. Or, the current bandwidth value may be a bandwidth value calculated after visiting a fixed-resource file that is used for such bandwidth measurement purpose. The current bandwidth value may also be null.

The current bandwidth value has a corresponding relationship with the file quality. The corresponding relationship may be defined according to a rule. According to a typical rule, a higher bandwidth value corresponds to a higher quality, and vice versa. The corresponding relationship between the current bandwidth value and the file quality can be preset or provided in time based on user feedback.

The client may choose an appropriate file quality according to the current bandwidth value, and the corresponding relationship between the current bandwidth value and the file quality. If current bandwidth value is null, the client may select the highest quality by default.

At block S203, the client receives from the server the file of the appropriate quality.

When receiving files returned from the server, the client records size of each file received, and the time spent on receiving each file.

Based on the file size and time to receive the file, the client may calculate a new value of the current bandwidth value and update it. Specifically, according to the size of each file and the time required to receive the file, the client may calculate a bandwidth value for each file separately using equation (1), and calculate an average current bandwidth value for all files received using the bandwidth values calculated separately for these files, using equation (3). The current bandwidth value may be set to be the average bandwidth value, and stored at the client.

The disclosed method is further described below from a server-centric point of view.

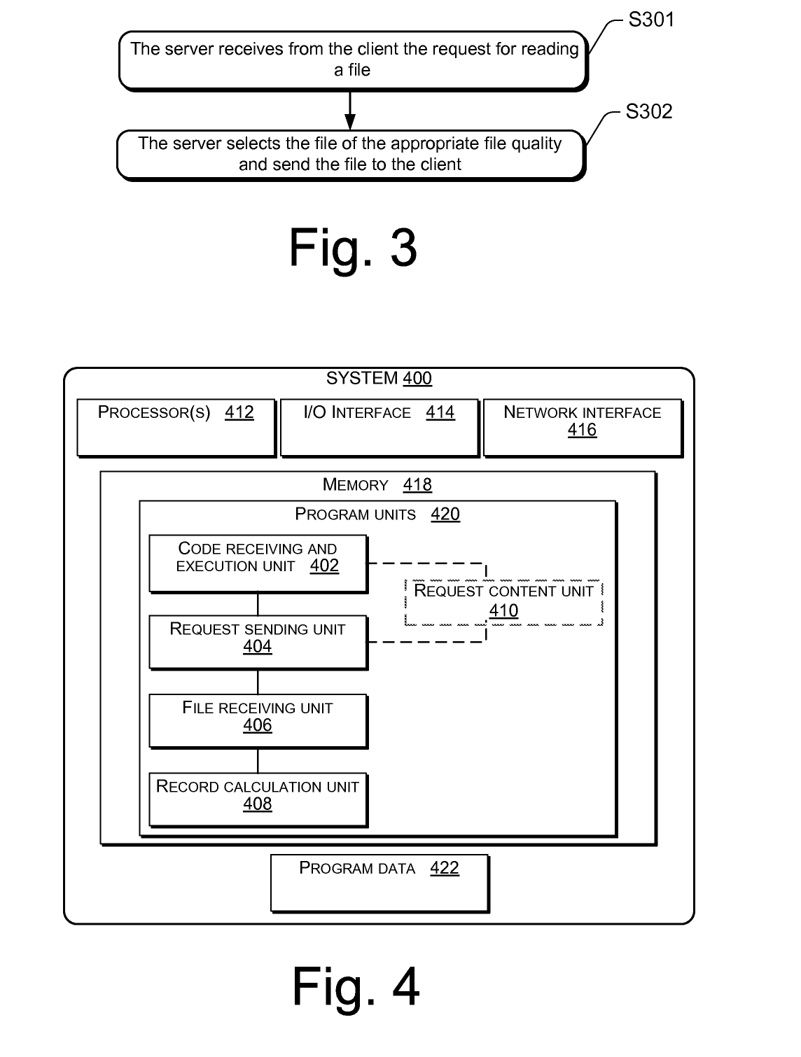

FIG. 3 is a flowchart of a server-centric process of the disclosed method for bandwidth-dependent file transfer.

At block S301, the server receives from the client the request for reading a file. The request may include a value of the current bandwidth, or the file quality corresponding to the current bandwidth.

If the request for reading a file includes a value of the current bandwidth, the server may select an appropriate file quality based on the corresponding relationship between the bandwidth values and various file qualities.

The current bandwidth value may include the client bandwidth values obtained in a previous file transfer. Or, the current bandwidth value may be a bandwidth value calculated after visiting a fixed-resource file that is used for such bandwidth value measurement purpose. The current bandwidth value may also be null. Examples of the method for calculating the current bandwidth value are described herein and not repeated.

The current bandwidth value has a corresponding relationship with the file quality, which may be defined according to a rule, as described herein.

The server may choose an appropriate file quality according to the current bandwidth value. If current bandwidth value is null, the server may select the highest quality by default.

At block S302, the server selects the file of an appropriate file quality and send the file to the client.

The server selects the file from multiple versions of the requested file according to the appropriate file quality determined at block S301, and returns the selected file to the client. The multiple versions of the requested file may be obtained by preprocessing the original file and stored at the server. Alternatively, the selected file may be obtained by processing the original file according to the selected file quality.

The association between the file and its corresponding file quality may be achieved using URL addresses. For example, a unique URL address may be set for each file quality to locate a version of the file corresponding to the respective file quality.

The requested file may be preprocessed to obtain the different compression versions of the requested file, which are stored at the server at a corresponding URL address. The server selects the URL corresponding to the current file quality, visits the URL to retrieve the corresponding version of file and return it to the client.

Alternatively, the requested file may be processed to obtain the different compression versions of the requested file upon receiving from the client the request for reading the file. For example, the server may set a URL for each file quality, but does not preprocess the file to obtain and store compressed files at these URL addresses until requested. When requested, the server analyzes the URL corresponding to the current file quality to determine an appropriate file quality, processes the original file accordingly to obtain a compressed file of the appropriate file quality, and returns the compressed file to the client.

According to another aspect of this disclosed method for bandwidth-dependent file transferring, after sending to the client the requested file at the selected quality level, the server then instructs the client to update the current bandwidth value according to, at least partially, a speed that the client has read the requested file. The updated current bandwidth value is used for reading a next file or browsing a next webpage.

In summary, the disclosed method for bandwidth-dependent file transfer establishes a corresponding relationship between bandwidth values and file quality levels to provide a requested file at a file quality appropriate to the network condition experienced by the user. The method calculates and updates in real time the current bandwidth value based on the receiving conditions of the current files received, and provide an updated current bandwidth value for next file transfer. The bandwidth value used for the current file transfer is therefore constantly updated based on the file transfers occurred previously. As the network condition of the user changes, the method is able to provide an appropriate file quality automatically adjusted for the new network condition.

In connection to the method disclosed herein, the present disclosure also provides a computerized system for implementing the bandwidth-dependent file transfer method described herein. The system may include a computing device having a processor, computer-readable memory and storage medium, and I/O devices, wherein the computing device is programmed to perform acts as described herein in connection with the example methods.

The above-described techniques may be implemented with the help of one or more non-transitory computer-readable media containing computer-executable instructions.

In the presence disclosure, a “module” in general refers to a functionality designed to perform a particular task or function. A module can be a piece of hardware, software, a plan or scheme, or a combination thereof, for effectuating a purpose associated with the particular task or function. In addition, delineation of separate modules does not necessarily suggest that physically separate devices are used. Instead, the delineation may be only functional, and the functions of several modules may be performed by a single combined device or component. When used in a computer-based system, regular computer components such as a processor, a storage and memory may be programmed to function as one or more modules to perform the various respective functions.

FIG. 4 is a block diagram of a system implementing a client-centric process of the disclosed method for bandwidth-dependent file transfer. As shown in FIG. 4, the system 400 includes code receiving and execution unit 402, request sending unit 404 and file receiving unit 406.

The code receiving unit and execution 402 is be used to receive a webpage code from a server, and to execute the received webpage code.

The request unit 404 is be used to send a request to read files to the server. The request to read files may include a current bandwidth value or specifies a file quality corresponding to the current bandwidth value.

The file receiving unit 406 is used for receiving the file of an appropriate file quality from the server.

The system 400 may also include record calculation unit 408 used to record the file sizes received at the file receiving unit 406 and the times taken to receive the files at the file receiving unit 406, and to calculate a new current bandwidth value of the current file transfer based on the recorded file size and receiving time data.

In an embodiment, the system for bandwidth-dependent file transfer may further include request content unit 410 which selects the file quality according to the current bandwidth value, and includes the selected file quality in the request to read files, such that the request specifies the file quality corresponding to the current bandwidth value.

In an embodiment, the system 400 may further include one or more processors 412, an input/output (I/O) interface 414, a network interface 416 and memory 418. The memory 418 may include program units 420 and program data 422. The program units 420 may include the code receiving and execution unit 402, the request sending unit 404, the file receiving unit 406 and/or the record calculation unit 408 as described above.

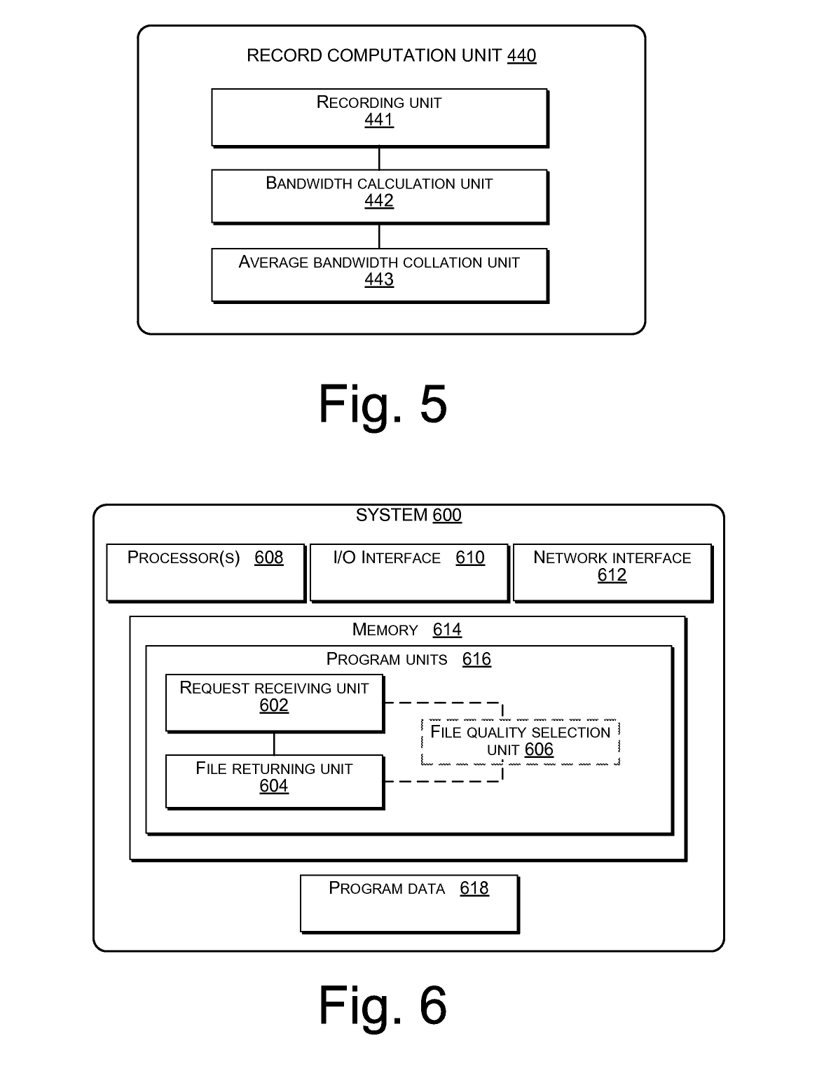

FIG. 5 is a block diagram of an example of the record calculation unit 408 used in the system of FIG. 4 for implementing a client-centric process of the disclosed method for bandwidth-dependent file transfer.

As shown in FIG. 5, the record calculation unit 408 includes recording unit 441, bandwidth calculation unit 442 and average bandwidth calculation unit 443.

The recording unit 441 is be used to record the file sizes and file receiving times of the files received by the file receiving unit 406.

The bandwidth calculation unit 442 is be used to calculate a bandwidth value for each file based on the respective recorded file size and the file receiving time of each file.

The average bandwidth calculation unit 443 calculates an average bandwidth value for the client based on individual bandwidth values for each received file, and sets the average bandwidth value to be the new current bandwidth value.

The above described with FIGS. 4-5 are examples of client-centric systems for implementing client-centric processes.

FIG. 6 is a block diagram of a system implementing a server-centric process of the disclosed method for bandwidth-dependent file transfer.

As shown in FIGS. 6, the system 600 includes request receiving unit 602 and file returning unit 604.

The request receiving unit 602 is used to receive from a client requests to read files. The request may include the current bandwidth value or the file quality corresponding to the current bandwidth value.

The file returning unit 604 is used to return to the client a file of an appropriate file quality as specified in the request received from the client.

If the request received at the request receiving unit 602 includes the current bandwidth value, the system may further include a file quality selection unit 606 for selecting a file quality corresponding to the current bandwidth value.

Additionally, in an embodiment, the system 600 may further include one or more processors 608, an input/output (I/O) interface 610, a network interface 612 and memory 614. The memory 614 may include program units 616 and program data 618. In an embodiment, the program units 616 may include the request receiving unit 602, the file returning unit 604 and/or the file quality selection unit 606 as described above.

The above described with FIG. 6 is an example of server-centric systems for implementing server-centric processes.

The disclosed methods and systems may be implemented by either hardware modules or software modules. The modules in particular may be implemented using computer program modules based on machine executable commands and codes. Generally, a computer program module may perform particular tasks or implement particular abstract data types of routines, programs, objects, components, data structures, and so on. Techniques described in the present disclosure can also be practiced in distributed computing environments, such a distributed computing environment, to perform the tasks by remote processing devices connected through a communication network. In a distributed computing environment, program modules may be located in either local or remote computer storage media including memory devices.

With earlier technologies, hardware implementations (e.g., improvements to diodes, transistors, switches and circuits) and software implementations (e.g., improvements to a method or a process) may be clearly distinguishable. However, with the more recent developments of the technologies, processes can be achieved by directly modifying the hardware structure. Improvements to a method or a process can be programmed into the hardware circuits to result in an appropriate hardware in circuit structure. In other words, a process may be realized using hardware modules as well as software modules. Examples of available means may include programmable logic devices (Programmable Logic Device, or PLD) such as a field programmable gate array (Field Programmable Gate Array, or FPGA), which is an integrated circuit that allows logic functions to be realized by programming the device using hardware description language (Hardware Description Language, or HDL). Examples of HDL include ABEL (Advanced Boolean Expression Language), AHDL (Altera Hardware Description Language), Confluence, CUPL (Cornell University Programming Language), HDCal and JHDL (Java Hardware Description Language), Lava, Lola, MyHDL, PALASM and RHDL (Ruby Hardware Description Language). Currently, by far the most common HDL is VHDL (Very-High-Speed Integrated Circuit Hardware Description Language) and Verilog2. Those who are skilled in the art may use any available hardware description language for logic programming into integrated circuits, to realize the methods and systems described herein.

Controllers can be implemented by any appropriate means, such as a microprocessor or any device that can store computer-readable program codes (such as software or firmware) executable by a microprocessor. Examples of such means include computer readable media, logic gates, switches and ASICs (Application Specific Integrated Circuit), programmable logic controllers and embedded micro-controller. A memory controller can also be implemented as part of the control logic of the memory.

The technique described in the present disclosure may be implemented in a general computing equipment or environment or a specialized computing equipment or environment, including but not limited to personal computers, server computers, hand-held devices or portable devices, tablet devices, multiprocessor systems, microprocessor-based systems, set-top boxes, programmable consumer devices, network PCs, microcomputers and large-scale mainframe computers, or any distributed environment including one or more of the above examples.

In a typical configuration, a computing device includes one or more processors (CPU), input/output interfaces, network interfaces, and memory. The memory may include a computer-readable medium such as a volatile memory, random access memory (RAM) and/or other forms of nonvolatile memory, such as read only memory (ROM) or flash memory (flash RAM). The internal memory of a computing device is a type of computer-readable memory medium. For example, the memory 418 of the system 400 and the memory 614 of the system 600 are an example of computer-readable media.

The computer-readable media include permanent and non-permanent, removable and non-removable media, and may be formed in any method or technology for storage of information. Information stored may be a set of computer-readable instructions, data structures, program modules or other data. Examples of the computer storage media include, but are not limited to, phase-change memory (PRAM), a static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storages, magnetic cassettes, magnetic tape disk storage or other magnetic storage devices, or any other non-transmission medium that may be used to store information accessible by a computing device. According to definitions of the present disclosure, computer-readable media do not include temporary computer readable media (transitory media), such as a modulated data signal and a carrier wave.

Various embodiments of the present specification are described progressively increased details with examples and environments. Each embodiment may focus a certain aspect of the disclosure, and therefore different embodiments may differ from one another, but may also share similar parts.

Exemplary embodiments are employed to illustrate the concept and implementation of the present invention in this disclosure. The exemplary embodiments are only used for better understanding of the method and the core concepts of the present disclosure. Based on the concepts in this disclosure, one of ordinary skills in the art may modify the exemplary embodiments and application fields.

What is claimed is:

1. A method for bandwidth-dependent file transferring, the method comprising:
sending to a client a webpage code concerning a current bandwidth value;
receiving from the client a request for reading a file at a server, the file can be sent at a plurality of quality levels;
selecting one of the plurality of quality levels that is appropriate to the current bandwidth value; and
sending from the server to the client the requested file at the selected quality level.

2. The method as recited in claim 1, wherein the webpage code concerning the current bandwidth value comprises an instruction for the client to update the current bandwidth value by measuring a speed of reading the requested file.

3. The method as recited in claim 1, wherein the webpage code concerning the current bandwidth value comprises corresponding relationships between the plurality of quality levels and various values of the current bandwidth.

4. The method as recited in claim 1, further comprising:
providing a plurality of versions of the requested file, each version representing one of the plurality of quality levels, wherein the sending from the server to the client the requested file at the selected quality level comprises sending one of the plurality of versions representing the selected one of the plurality of quality levels.

5. The method as recited in claim 4, wherein the providing the plurality of versions of the requested file comprising:
pre-processing the requested file to obtain the plurality of versions of the requested file; and
storing the plurality of versions of the requested file.

6. The method as recited in claim 4, wherein the providing the plurality of versions of the requested file comprising:
processing the requested file to obtain the plurality of versions of the requested file upon receiving from the client a request for reading the file.

7. The method as recited in claim 1, wherein the selecting one of the plurality of quality levels of the requested file appropriate to the current bandwidth value comprises:
determining, at the client, one of the plurality of quality levels according to the current bandwidth value; and
specifying the determined quality level in the request for reading the file.

8. The method as recited in claim 1, wherein the selecting one of the plurality of quality levels of the requested file appropriate to the current bandwidth value comprises:
pre-configuring a bandwidth-quality table which relates various ranges of bandwidths value to the plurality of quality levels; and
selecting, according to the bandwidth-quality table, one of the plurality of quality levels of the requested file corresponding to the current bandwidth value.

9. The method as recited in claim 8, wherein the bandwidth-quality table is available at the server, and the selecting one of the plurality of quality levels of the requested file appropriate to the current bandwidth value is conducted by the server.

10. The method as recited in claim 8, wherein the bandwidth-quality table is available at the client, and the selecting one of the plurality of quality levels of the requested file appropriate to the current bandwidth is conducted by the client.

11. The method as recited in claim 1, wherein the request for reading the file specifies one of the plurality of quality levels appropriate to the current bandwidth value.

12. The method as recited in claim 1, wherein the request for reading the file specifies a value of the current bandwidth value.

13. The method as recited in claim 1, wherein the current bandwidth value comprises a value of bandwidth calculated from a speed of reading a previous file by the client.

14. The method as recited in claim 13, wherein the previous file is an image file having a file size calculated by multiplying a pixel number in length, a pixel number in height and an imaging coefficient, the speed of reading the previous file being calculated by dividing the file size by a time taken to receive the image file.

15. The method as recited in claim 13, wherein the previous file read by the client is a part of a webpage requested by the client.

16. The method as recited in claim 1, wherein the current bandwidth value comprises a value of bandwidth calculated from averaging speeds of reading a plurality of previous file by the client.

17. A method for bandwidth-dependent file transferring, the method comprising:
receiving from the client a request for reading a file at a server, the file can be sent at a plurality of quality levels;
selecting one of the plurality of quality levels of the requested file appropriate to a current bandwidth value;
sending from the server to the client the requested file at the selected quality level; and
instructing the client to update the current bandwidth value according to, at least partially, a length of time used for receiving the requested file.

18. The method as recited in claim 17, further comprising:
providing a plurality of versions of the requested file, each version representing one of the plurality of quality levels, wherein the sending from the server to the client the requested file at the selected quality level comprises sending one of the plurality of versions representing the selected one of the various quality levels.

19. The method as recited in claim 17, wherein the selecting one of the plurality of quality levels of the requested file appropriate to the current bandwidth comprises:
pre-configuring a bandwidth-quality table which relates various ranges of bandwidth values to the plurality of quality levels; and
selecting, according to the bandwidth-quality table, one of the plurality of quality levels of the requested file corresponding to the current bandwidth value.

20. A computerized system for bandwidth-dependent file transferring, the system comprising a computing device having a processor, computer-readable memory and storage medium, and I/O devices, wherein the computing device is programmed to perform acts including:
sending to a client a webpage code concerning a current bandwidth value;
receiving from the client a request for reading a file at a server, wherein the file can be sent at various quality levels;
selecting one of the various quality levels of the requested file appropriate to the current bandwidth value; and
sending from the server to the client the requested file at the selected quality level.
